(19) United States
(12) Patent Application Publication
(10) Pub. No.: US 2005/0026499 A1
(43) Pub. Date: Feb. 3, 2005

(54) Connector and notebook computer system using the same

(76) Inventor: Jae-chun Choi, Yongin-city (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/872,787

(22) Filed: Jun. 22, 2004

(30) Foreign Application Priority Data
Jun. 23, 2003 (KR) 2003-40848

(51) Int. Cl. H01R 13/648

(52) U.S. Cl. 439/607

(57) ABSTRACT

The present invention relates to a connector and a notebook computer system having the same, wherein the connector comprises a connector body provided in the first electronic device and having at least one terminal; a shield combined with the connector body and grounded to a grounding part of the first electronic device; and at least one grounding member provided on the shield so as to grounding-connect a grounding part of the second electronic device with the shield. With this configuration, the present invention provides a connector and a notebook computer system using the same, which is improved in suppressing RF noise between the pair of electronic devices connected by the connector, assembling the notebook computer system efficiently, and decreasing production cost thereof.

### CROSS-REFERENCE TO RELATED APPLICATIONS

This application claims the benefit of Korean Patent Application No. 2003-40848, filed Jun. 23, 2003, in the Korean Intellectual Property Office, the entire contents of which is incorporated herein by reference in its entirety.

### BACKGROUND OF THE INVENTION

1. Field of the Invention

The present invention relates to a connector and a notebook computer system using the same. More particularly, the present invention relates to a connector and a notebook computer system using the same which is improved in suppressing radio frequency (RF) noise.

2. Description of the Related Art

Generally, a connector is used to electrically connect electronic devices to each other.

In FIG. 8, a conventional notebook computer system using a conventional connector is illustrated. The conventional notebook computer system 109 comprises a notebook computer 110 having a central processing unit (CPU), and a docking station 130 detachably connected to the notebook computer 110 and cooperating with the notebook computer 110. The notebook computer 110 and the docking station 130 are electrically connected by a pair of connectors 117 and 140, so that data is transmitted between the notebook computer 110 and the docking station 130 through the connectors 117 and 140.

In such a notebook computer system comprising the notebook computer and the docking station which are respectively provided as independent systems and connected, a potential difference between the notebook computer and the docking station should be reduced so as to suppress an RF noise.

In order to increase ground-contact between a grounding part 123 provided on a chassis 113 of the notebook computer 110 and a grounding part (not shown) provided on a chassis 131 of the docking station 130, and in order to suppress the RF noise by minimizing the potential difference, the conventional notebook computer system 109 comprises a plurality of ground-contact metal parts 139 provided in the docking station 130 so as to contact the grounding parts 123 provided in the chassis 113 of the notebook computer 110 as well as a shield 151 of the connector 140 provided in the docking station 130 so as to electrically connect the notebook computer 110 with the docking station. Here, the ground-contact metal parts 139 are provided inside the chassis 131 of the docking station 130, protruding from the docking station 130.

As described above, in the conventional notebook computer system, the shield of the connector is employed for increasing the ground-contact between the notebook computer and the docking station, but the shield of the connector is not expected to give stable ground-contact. Therefore, the plurality of ground-contact metal parts along the surface of the chassis of the docking station are needed in addition to the shield 151 of the docking station connector. However, it is not easy to install the ground-contact metal parts in the notebook computer system, so that efficiency of assembling the notebook computer system is decreased and production cost thereof is increased. Further, because the ground-contact metal parts are decentralized on the surface of the chassis of the docking station, the RF noise is not suppressed in the vicinity of the connector and is distributed through each surface of the chassis of the notebook computer and of the docking station, corresponding to the positions of the ground-contact metal parts. Further, because contact resistance between the notebook computer and the chassis of the docking station widely varies according to the contact resistance between the ground-contact metal part and the shield of the connector, between the shield of the connector and the grounding part of a circuit board of the docking station, between the ground-contact metal and the chassis of the notebook computer, and so on, it may be counterproductive in suppressing the RF noise.

### SUMMARY OF THE INVENTION

Accordingly, it is an aspect of the present invention to provide a connector and a notebook computer system using the same, which is improved in suppressing RF noise, assembling the notebook computer system efficiently, and decreasing the production cost thereof.

Additional aspects and advantages of the invention will be apparent to those of ordinary skill in the art, and will be set forth in part in the description which follows and, in part, will be obvious from the description, or may be learned by practice of the invention.

The foregoing and other aspects of the present invention are achieved by providing a connector electrically connecting a pair of first and second electronic devices, comprising a connector body provided in the first electronic device and having at least one terminal; a shield combined with the connector body and grounded to a grounding part of the first electronic device; and at least one grounding member provided on the shield so as to grounding-connect a grounding part of the second electronic device with the shield.

According to an aspect of the invention, the grounding member is made of conductive material and protrudes from a surface of the shield.

According to an aspect of the invention, the grounding member is elastically biased in a direction that the electronic devices move away from each other.

According to an aspect of the invention, the grounding member comprises a grounding pin provided on the surface of the shield and movable up and down; and a spring supporting one end of the grounding pin, and elastically biasing the grounding pin in a direction that the electronic devices move away from each other.

According to another aspect of the present invention, the above and other aspects may also be achieved by providing a notebook computer system having a notebook computer, and a docking station electrically connected with the notebook computer and cooperating with the notebook computer. The system comprises a connector to electrically connect the notebook computer with the docking station. The connector comprises a connector provided in either of the notebook computer or the docking station, and having at least one terminal; a shield combined with the connector body, and grounded to a grounding part of one of the notebook computer and the docking station; and at least one grounding member provided on the shield so as to grounding-connect a grounding part of the other one of the notebook computer and the docking station with the shield.

According to an aspect of the invention, the grounding member is made of conductive material and protrudes from a surface of the shield.

According to an aspect of the invention, the grounding member is elastically biased in a direction that the electronic devices move away from each other.

According to an aspect of the invention, the grounding member comprises a grounding pin provided on the surface of the shield and movable up and down; and a spring supporting one end of the grounding pin, and elastically biasing the grounding pin in a direction that the electronic devices move away from each other.

### BRIEF DESCRIPTION OF THE DRAWINGS

These and other aspects and advantages of the present invention will become apparent and more readily appreciated from the following description of the embodiments, taken in conjunction with the accompanying drawings, in which:

FIG. 1 is a perspective view of a notebook computer and a docking station in a notebook computer system according to a first embodiment of the present invention;

FIG. 2 is a perspective view of a connector according to the first embodiment of the present invention;

FIG. 3 is an exploded perspective view of the connector of FIG. 2;

FIG. 4 is a side view of the connector of FIG. 2;

FIG. 5 is a perspective view of a connector according to a second embodiment of the present invention;

FIG. 6 is a sectional view of the connector, taken along line VI-VI in FIG. 5;

FIG. 7 is a sectional view of the connector when the notebook computer system and the docking station are combined; and

FIG. 8 is a perspective view of a notebook computer and a docking station in a conventional notebook computer system.

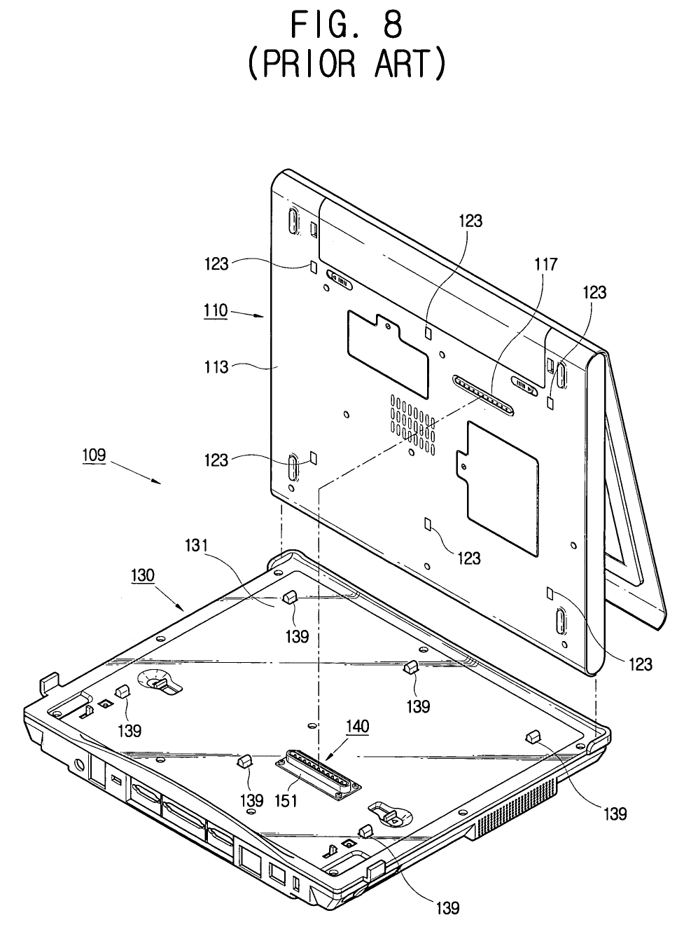

### DETAILED DESCRIPTION OF THE PREFERRED EMBODIMENT

Reference will now be made in detail to the embodiments of the present invention, examples of which are illustrated in the accompanying drawings, wherein like reference numerals refer to like elements throughout. The embodiments are described below in order to explain the present invention by referring to the figures.

Hereinafter, an exemplary notebook computer system will be described as a system comprising a pair of electronic devices.

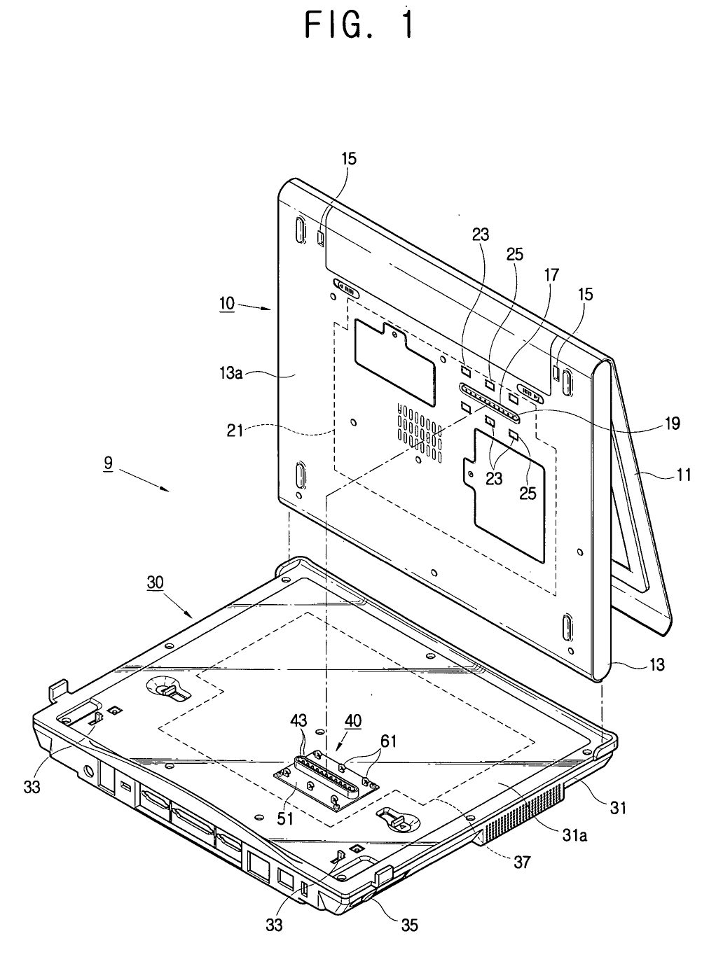

FIG. 1 is a perspective view of a notebook computer and a docking station in a notebook computer system according to a first embodiment of the present invention. As shown therein, a notebook computer system 9 comprises a notebook computer 10 having a CPU (not shown) and a display part 11 receiving a video signal from the notebook computer 10 and displaying a picture thereon; and a docking station 30 detachably combined with a bottom of the notebook computer 10 and cooperating with the notebook computer 10.

The notebook computer 10 is preferably provided with a keyboard (not shown) and a touch pad (not shown) as an input unit. The notebook computer 10 comprises a chassis 13 forming an outer appearance, and a circuit board 21 provided inside the chassis 13. On a bottom plate 13a of the chassis 13 of the notebook computer 10 is provided a pair of hook grooves 15 at which a pair of hooks 33 (to be described in further detail below) is locked to and released from. Further, on a bottom plate 13a of the chassis 13 of the notebook computer 10 is provided a computer connector 17 to be electrically connected with a docking connector 40 (to be described in further detail below).

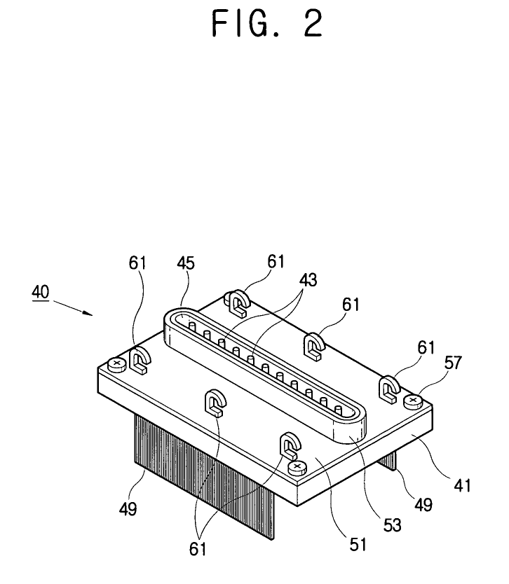

The computer connector 17 is provided with a plurality of terminal receiving holes 19 to receive a plurality of terminals 43 of the docking connector 40. Around the computer connector 17, a plurality of grounding through holes 25 are formed on the bottom plate 13a of the chassis 13 of the notebook computer 10 so as to expose a grounding part 23 of the circuit board 21 provided in the notebook computer 10 to the outside. In the notebook computer 10, the grounding part 23 of the circuit board 21 is electrically connected with a grounding part (not shown) of the chassis 13, and exposed to the outside through the grounding through holes 25 so as to electrically contact a grounding member 61 (refer to FIG. 2) of the docking connector 40.

The docking station 30 comprises a chassis 31 forming an outer appearance, and a circuit board 37 provided inside the chassis 13. On an upper plate 31a of the chassis 31 of the docking station 30 is provided the pair of hooks 33 corresponding to the hook grooves 15. On an opposite sides of the chassis 31 are movably provided levers 35 to operate the hooks 35, respectively. Thus, the hooks 33 of the docking station 30 are locked to and released from the hook grooves 15 of the notebook computer 10 by moving the levers 35, so that the notebook computer 10 is detachably connected to the docking station.

Further, on the upper plate 31a of the chassis 31 of the docking station 30 is provided the docking connector 40 to be electrically connected with the computer connector 17.

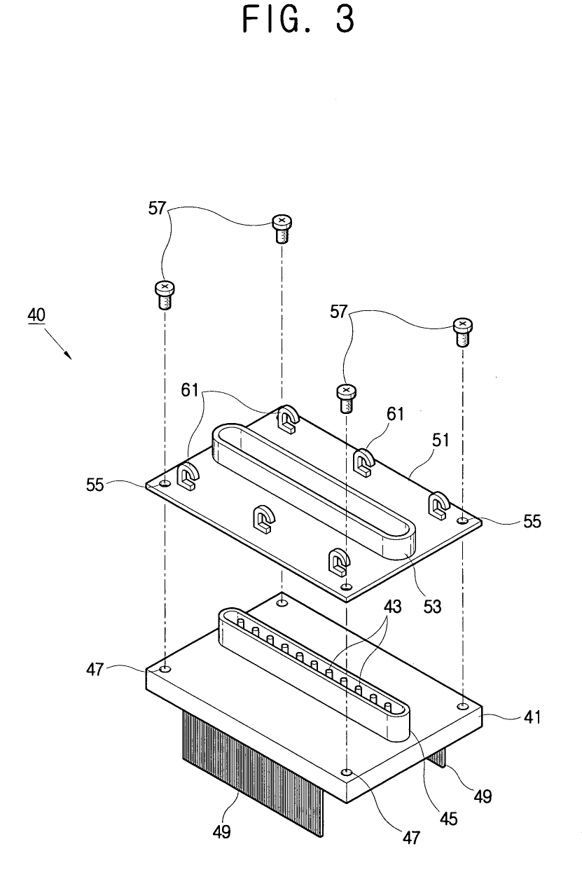

As shown in FIGS. 2 through 4, the docking connector 40 according to the first embodiment of the present invention comprises a connector body 41 having a plurality of terminals 43 and connected to the circuit board 37 of the docking station 30; a shield 51 combined with the connector body 41 and grounded to the grounding part (not shown) of the circuit part 37 of the docking station 30; and a plurality of grounding member 61 provided on the shield 51 and electrically connecting the grounding part 23 of the circuit board 21 provided in the notebook computer 10 with the shield 51 so as to ground the grounding part 23.

On an upper surface of the connector body 41 is protruded a terminal accommodating part 45 accommodating the plurality of terminals 43 to be inserted in the terminal receiving holes 19 of the computer connector 17. Further, on the upper surface of the connector body 41 a pair of screw holes 47 are preferably formed symmetrical to the terminal accommodating part 45.

On a bottom surface of the connector body 41 is provided a pair of pin parts 49 disposed at opposite edges of the connector body 41 and formed with a plurality of pins to be connected to the circuit board 37 of the docking station 30.

The shield 51 is made of conductive material, and formed with a sleeve 53 to surround the terminal accommodating part 45. The shield 51 is formed with a pair of screw through holes 55 through which screws 57 pass, so that the shield 51 is combined to the upper surface of the connector body 41, being grounded to the grounding part of the circuit board 37 of the docking station 30. Here, in the docking station 30, the grounding part of the circuit board 37 is electrically connected with the grounding part of the chassis 31.

The plurality of grounding members 61 preferably protrude along a circumference of the sleeve 53. The grounding member 61 is preferably shaped like a hook, and arranged corresponding to the grounding part 23 provided in the circuit board 21 of the notebook computer 10 and exposed to the outside through the grounding through holes 25. The grounding member 61 is made of conductive material so as to electrically connect the shield 51 with the grounding part 23 of the circuit board 21 provided in the notebook computer 10, and elastically biased in a direction that the notebook computer 10 moves away from the docking station 30.

When the notebook computer 10 is combined with the docking station 30, the grounding members 61 are elastically deformed, being in contact with the grounding part 23 of the circuit board 21 provided in the notebook computer 10, so that the grounding part 23 of the circuit board 21 provided in the notebook computer 10 is grounded to the shield 51. Hence, the chassis 13 and the circuit board 21 of the notebook computer 10, the shield 51 and the grounding member 61 of the docking connector 40, and the chassis 31 and the circuit board 37 of the docking station 30 are electrically connected and grounded to one another through the grounding parts, so that an RF noise generated between the notebook computer 10 and the docking station 30 is concentrated on the docking connector 40 and then suppressed. Oppositely, when the notebook computer 10 is detached from the docking station 30, the grounding members 61 are restored, being elastically biased in the direction that the notebook computer 10 moves away from the docking station 30.

With this configuration, as shown in FIG. 1, the hooks 33 of the docking station 30 using the docking connector 40 according to the first embodiment of the present invention are locked to the hook grooves 15 of the notebook computer 10, and the docking connector 40 is electrically connected to the computer connector 17, thereby combining the notebook computer 10 to the docking station 30.

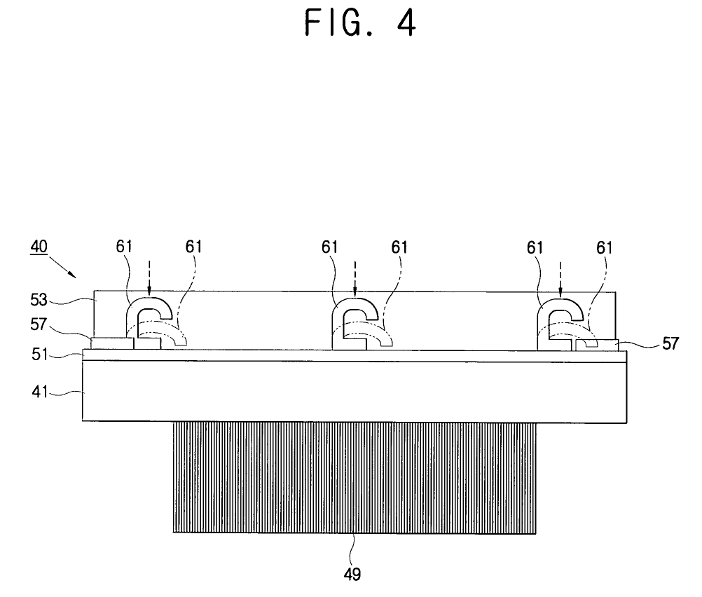

Here, when the notebook computer 10 is combined to the docking station 30, the grounding members 61 of the docking connector 40 are elastically deformed toward the surface of the shield 51 (refer to a dotted line in FIG. 4), so that upper parts of the grounding members 61 is in contact with the grounding part 23 of the circuit board 21 provided in the notebook computer 10, thereby grounding the grounding part 23 of the circuit board 21 provided in the notebook computer to the shield 51.

Thus, the chassis 13 and the circuit board 21 of the notebook computer 10, the shield 51 and the grounding member 61 of the docking connector 40, and the chassis 31 and the circuit board 37 of the docking station 30 are electrically connected and grounded to one another through the grounding parts. Therefore, the RF noise is concentrated on the docking connector 40 without being decentralized throughout the surfaces of the notebook computer 10 and the docking station 30. Also, the RF noise is decreased by the docking connector 40 because contact resistance between the notebook computer 10 and the docking station 30 is lowered, thereby suppressing the RF noise between the notebook computer 10 and the docking station 30. Further, according to an embodiment of the present invention, a separate ground contact metal part is not needed in either of the notebook computer or the docking station, so that efficiency in assembling the notebook computer system is improved, and production costs are decreased.

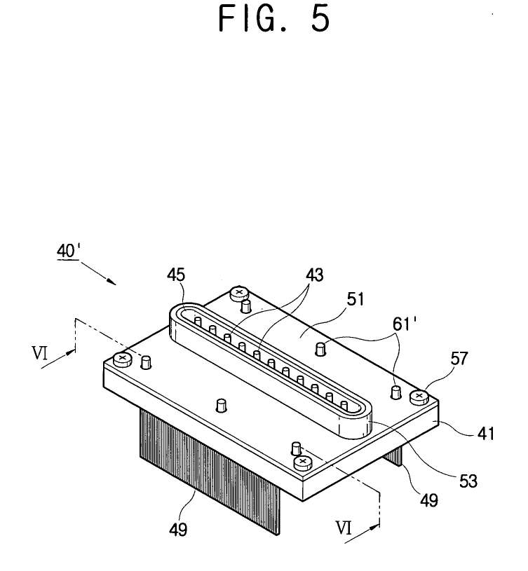

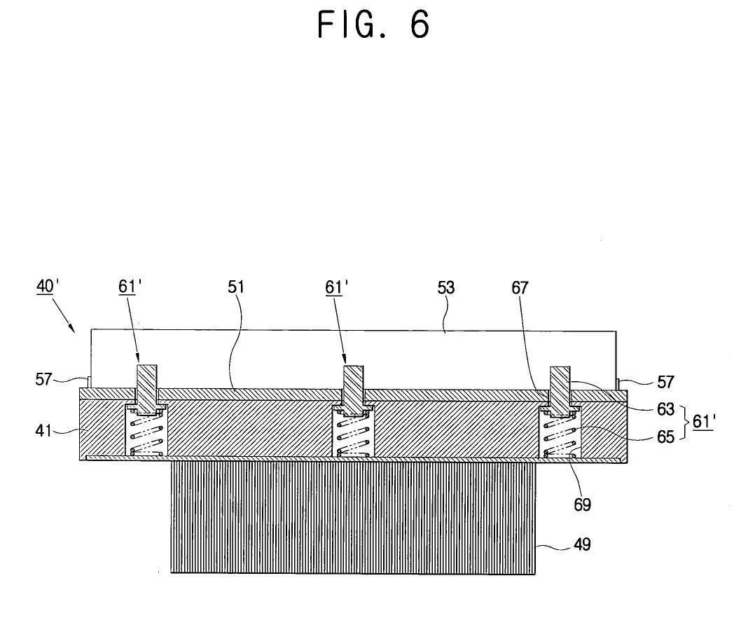

FIGS. 5 through 7 illustrate a docking connector according to a second embodiment of the present invention. As shown therein, contrary to the first embodiment, a docking connector 40′ according to the second embodiment of the present invention comprises a plurality of grounding members 61′ provided on a shield 51 and elastically moving up and down relative to the shield 51.

Each grounding member 61′ comprises a grounding pin 63 bound by the shield 51 and movable up and down relative to the shield 51, and a spring 65 supporting one end of the grounding pin 63 and elastically biasing the grounding pin 63 in a direction that the notebook computer 10 moves away from the docking station 30.

The grounding pin 63 preferably has a circular cross-section, and its free end is in contact with and separated from the grounding part 23 of the circuit board 21 provided in the notebook computer 10. Here, the grounding pin 63 passes through a pin through hole 67 formed on the shield 51, so that the grounding pin 63 moves up and down being guided by the pin through hole 67.

The spring 65 is accommodated in a guiding groove 69 formed in the connector body 41 so as to support the one end of the grounding pin 63, thereby elastically biasing the grounding pin 63.

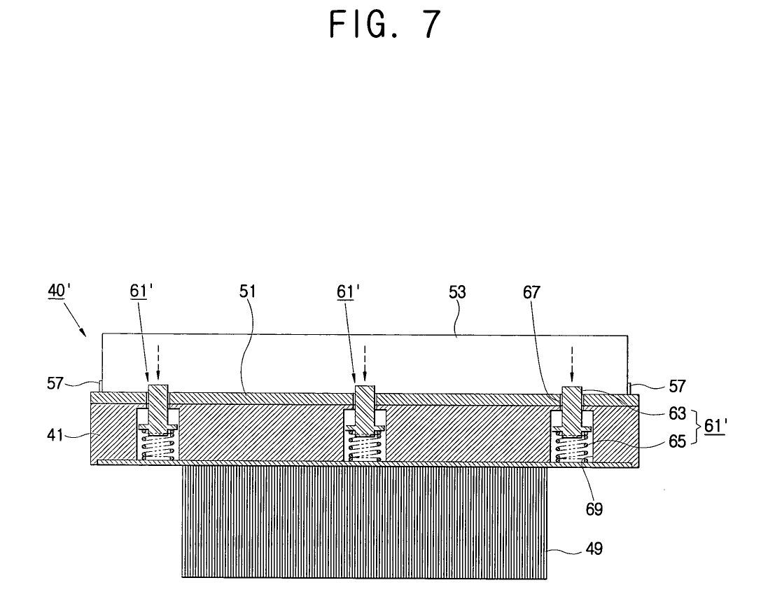

With this configuration, when the notebook computer 10 is combined to the docking station 30, the grounding pin 63 of the grounding member 61′ moves down, as shown in FIG. 7, compressing the spring 65. At the same time the free end of the grounding pin 63 contacts the grounding part of the circuit board 21 provided in the notebook computer 10, so that the grounding part 23 of the circuit board 21 provided in the notebook computer 10 is electrically connected and grounded to the shield 51. Hence, the chassis 13 and the circuit board 21 of the notebook computer 10, the shield 51 and the grounding member 61′ of the docking connector 40′, and the chassis 31 and the circuit board 37 of the docking station 30 are electrically connected and grounded to one another through the grounding parts, so that the RF noise is concentrated on the docking connector 40′ without being decentralized throughout the surfaces of the notebook computer 10 and the docking station 30. The RF noise is also decreased by the docking connector 40′.

As described above, there is provided at least one grounding member protruding along the surface of the shield of the connector, so that the contact resistance between the pair of electronic devices forming the system is decreased, and the RF noise is concentrated on the connector and decreased by the connector, thereby suppressing the RF noise between the electronic devices, improving the assembling efficiency of the system, and decreasing the production cost thereof.

In the above-described embodiments according to embodiments of the present invention, the connector is provided in the docking station, but may also be provided in the notebook computer instead, as will be appreciated by those of ordinary skill in the art.

As described above, there is provided at least one grounding member provided on a surface of a shield of a connector and grounding a grounding part of an electronic device to the shield, so that embodiments of the present invention provide a connector and a notebook computer system using the same, which is improved in suppressing an RF noise between the pair of electronic devices connected by the connector, assembling the notebook computer system efficiently, and decreasing production cost thereof.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A connector for electrically connecting a pair of first and second electronic devices, comprising:
a connector body provided in the first electronic device and having at least one terminal;
a shield combined with the connector body and grounded to a grounding part of the first electronic device; and
at least one grounding member provided on the shield so as to grounding-connect a grounding part of the second electronic device with the shield.

2. The connector according to claim 1, wherein the grounding member includes conductive material and protrudes from a surface of the shield.

3. The connector according to claim 2, wherein the grounding member is elastically biased in a direction that the electronic devices move away from each other.

4. The connector according to claim 1, wherein the grounding member comprises:
a grounding pin provided on the surface of the shield and movable up and down; and
a spring supporting one end of the grounding pin, and elastically biasing the grounding pin in a direction that the electronic devices move away from each other.

5. A notebook computer system having a notebook computer, and a docking station electrically connected with the notebook computer and cooperating with the notebook computer, comprising:
a connector to electrically connect the notebook computer with the docking station,
the connector comprising:
a connector provided in either of the notebook computer or the docking station, and having at least one terminal;
a shield combined with the connector body, and grounded to a grounding part of one of the notebook computer and the docking station; and
at least one grounding member provided on the shield so as to grounding-connect a grounding part of the other one of the notebook computer and the docking station with the shield.

6. The notebook computer system according to claim 5, wherein the grounding member is made of conductive material and protrudes from a surface of the shield.

7. The notebook computer system according to claim 6, wherein the grounding member is elastically biased in a direction that the electronic devices move away from each other.

8. The connector according to claim 5, wherein the grounding member comprises:
a grounding pin provided on the surface of the shield and movable up and down; and
a spring supporting one end of the grounding pin, and elastically biasing the grounding pin in a direction that the electronic devices move away from each other.

9. A grounding device for creating an electically grounded connection between first and second electronic devices, the grounding device comprising:
a connector sleeve provided in the first electronic device and having at least one terminal;
a shield combined with the connector sleeve and grounded to a grounding part of the first electronic device; and
a plurality of grounding members provided on the shield and arranged along a circumference of the connector sleeve so as to grounding-connect a grounding part of the second electronic device with the shield.

10. The grounding device of claim 9, wherein the plurality of grounding members include conductive material and protrude from a surface of the shield.

11. The grounding device of claim 9, wherein the plurality of grounding members are elastically biased in a direction that the electronic devices move away from each other.

12. The grounding device of claim 9, wherein the plurality of grounding members each comprise:
a grounding pin provided on the surface of the shield and movable up and down; and
a spring supporting one end of the grounding pin, and elastically biasing the grounding pin in a direction that the electronic devices move away from each other.
